(19) United States
(12) Patent Application Publication
(10) Pub. No.: US 2011/0191581 A1
(43) Pub. Date: Aug. 4, 2011

(54) METHOD AND SYSTEM FOR USE IN MANAGING VEHICLE DIGITAL CERTIFICATES

(75) Inventors: Hyong-Sop Shim, Basking Ridge, NJ (US); Stanley Pietrowicz, Freehold, NJ (US); Tao Zhang, Fort Lee, NJ (US)

(73) Assignee: TELCORDIA TECHNOLOGIES, INC., Piscataway, NJ (US)

(21) Appl. No.: 12/846,055

(22) Filed: Jul. 29, 2010

Related U.S. Application Data
(60) Provisional application No. 61/237,414, filed on Aug. 27, 2009.

(51) Int. Cl. H04L 29/06

(52) U.S. Cl. 713/158

(57) ABSTRACT

A system and method is provided for managing digital certificates, the system including one or more a certificate authorities and a vehicle-bound digital certificate manager, the apparatus comprising: a mobile client having a wireless transceiver with internet protocol capabilities and a vehicle communication device; the client further including at least one processor and at least one non-transitory computer readable medium encoded with instructions, which when loaded on the at least one computer, establishes processes for information handling, comprising: establishing secure communications with a certificate authority to receive at least one of a Vehicle Identification Digital Certificate (“VIDC”), an Anonymous Vehicle digital Certificate (“AVDC”), and a Certificate Revocation Lists (“CRLs”); storage management of at least one of the VIDC, AVDCs, and CRLs; and forwarding of at least one of the VIDC, AVDCs, and CRLs received from the certificate authority to the digital certificate manager using the vehicle communication device.

### RELATED APPLICATION

This application claims priority from Provisional Application No. 61/237,414, filed Aug. 27, 2009, the contents of which are hereby expressly incorporated by reference.

### BACKGROUND

1. Technical Field

The present invention relates to the field of vehicle digital certificates management.

2. Description of the Related Art

In a typical Intelligent Transportation System (ITS), vehicles communicate with each other for a variety of applications, including safety, mobility, entertainment, and commerce. Vehicle-to-vehicle (V2V) communications allow vehicles to interact with each other via radio waves by sending and receiving information. This technology is expected to improve traffic safety, such as in the prevention of vehicle collisions. In particular, vehicles broadcasting messages alert nearby vehicles of accidents, sudden lane changes, hazardous road conditions, etc. and assist in the reduction of traffic jams and ultimately CO2 emissions.

Wireless radio devices are mounted in the vehicle. Preferably messages broadcast by the radio devices are cryptographically secured to ensure the message receivers of the authenticity and integrity of the message payloads and senders. These security functions are typically achieved with what is known in the field of cryptography as digital certificates.

In such a system, vehicles have a periodic need to receive updated Vehicle Identifying Digital Certificates (“VIDC”), updated Anonymous Vehicle Digital Certificates (“AVDCs”) and updated Certificate Revocation Lists (“CRLs”) to update their credentials, replace expired certificates, and be able to check the validity of messages signed with digital certificates. The challenge is to efficiently provide these updated VIDCs, AVDCs and CRLs in a manner consistent with the vehicle communications environment.

Distribution, update, and removal of digital certificates and CRLs, commonly known as digital certificate management, are an active area of research in vehicle networks. In general, individual vehicles communicate with a special component, called a Certificate Authority (CA) for certificate management. A CA is a computer server system that typically operates in a land-based network infrastructure and is accessed by vehicles through one or more networks access methods.

As the ITS evolves, it has become increasingly likely that the same wireless technologies used for V2V communications may (or will) not be available for vehicles-to-network infrastructure (V2I) communications needed for vehicles to communicate with CAs. Specifically, a particular WiFi-like technology, called Dedicated Short Range Communications (DSRC) is considered to be the most suitable wireless technology to realize V2V communications needed for broadcasting vehicle safety messages. However, it is highly unlikely that a DSRC network infrastructure needed for DSRC-equipped, vehicles to communicate with CAs and other application servers will be available anytime soon. Such a network would require the deployment of hundreds of thousands of DSRC access points along intersections and major roadways to create what is commonly referred to as the dedicated roadside network infrastructure.

An object of the present invention is to describe a system and method for enabling vehicle certificate management functions in a vehicle network environment that has no or very limited dedicated roadside network infrastructure. If DSRC is used, the present invention allows vehicles to manage their digital certificates even when they cannot use DSRC to communicate with land-based CAs.

### SUMMARY

It is important to understand that both the foregoing general description and the following detailed description are exemplary and explanatory only, and are not restrictive of the invention as claimed.

The present invention enables vehicles to update their identifying certificates (VIDCs) and anonymous certificates (AVDCs) and receive the latest CRLs through a proxy agent in a wireless mobile device, such as a cellular phone or personal digital assistant, that provides network connectivity and local storage of certificate updates and CRLs with a level of security and privacy similar to when the vehicle itself has direct connectivity with the CA to manage its certificates.

Specifically, the proxy agent, called the Proxy Certificate Authority (CA), proactively downloads and stores the latest CRLs and anonymous certificates to be rekeyed and transfers them to any vehicle that can establish network connections and communicate with it. In other words, the proxy agent provides a mobile cache of CRLs and anonymous certificates to be rekeyed for fast transfer to nearby vehicles.

Once a subset of the entire vehicle population is thus “seeded” with the latest CRLs and anonymous certificates, they can propagate the CRLs and update certificates to the rest of the population via V2V broadcast mechanisms. Therefore, the Proxy CA effectively enables vehicle certificate management in a vehicle network environment with no dedicated roadside infrastructure by reusing network connectivity that drivers are likely to bring into their vehicles to update certificates and distribute CRLs.

In other words, the present invention may be described as an apparatus for use in a system for managing digital certificates, the system including a one or more certificate authorities and a vehicle-bound digital certificate manager, the apparatus comprising: a mobile client having a wireless transceiver with internet protocol capabilities and a vehicle communication device; the client further including at least one processor and at least one non-transitory computer readable medium encoded with instructions, which when loaded on the at least one computer, establishes processes for information handling, comprising: establishing secure communications with a certificate authority to receive at least one of a Vehicle Identification Digital Certificate (“VIDC”), an Anonymous Vehicle digital Certificate (“AVDC”), and a Certificate Revocation List (“CRL”); storage management of at least one of the VIDCs, AVDCs, and CRLs; and forwarding of at least one of the VIDCs, AVDCs, and CRLs received from the certificate authority to the vehicle-bound digital certificate manager using the vehicle communication device. One or more of each of the VIDCs, AVDCs, and CRLs may be received.

Viewed differently, the invention may be described as an apparatus for use in a system for managing digital certificates, the system including a mobile client having a wireless transceiver with internet protocol capabilities, the apparatus comprising: a vehicle on-board computer unit, including a vehicle communication device and a vehicle-to-vehicle wireless communication device; the vehicle on-board computer unit further including at least one processor and at least one non-transitory computer readable medium encoded with instructions, which when loaded on the at least one computer, establishes processes for information handling, comprising: secure receipt from the mobile client via the vehicle communication device of at least one of a Vehicle Identification Digital Certificate (“VIDC”), one or more Anonymous Vehicle Digital Certificates (“AVDCs”), and a Certificate Revocation Lists (“CRLs”); storage management of at least one of the VIDCs, AVDCs, and CRLs received from the mobile client; and forwarding of at least one of the AVDCs, and CRLs received from the mobile client to another vehicle using the vehicle-to-vehicle wireless communication device. Again, one or more of each of the VIDCs, AVDCs, and CRLs may be received.

The invention may also be described as a method for managing digital certificates in a system including a certificate authority and a vehicle-bound digital certificate manager, the method comprising: a wireless client establishing secure communications with from the certificate authority using its native network means and receiving at least one of a Vehicle Identification Digital Certificate (“VIDC”), an Anonymous Vehicle Digital Certificates (“AVDCs”), and Certificate Revocation Lists (“CRLs”); storing at least one of the VIDC, AVDCs, and CRL; and forwarding of at least one of the VIDCs, AVDCs, and CRLs from the wireless client to the vehicle-bound digital certificate manager using a vehicle communication device. And again, one or more of each of the VIDCs, AVDCs, and CRLs may be received.

The method of the present invention may further comprise: forwarding of at least one of the AVDCs and CRLS received from the mobile client to another vehicle using a vehicle-to-vehicle wireless communication device.

### BRIEF DESCRIPTION OF THE DRAWINGS

The accompanying drawings, which are incorporated in and constitute a part of this specification, illustrate various embodiments. In the drawings:

FIG. 1 illustrates Proxy CA architectural components;

FIG. 2 illustrates vehicle data transfer protocol;

FIG. 3 illustrates CRL distribution with a Proxy CA;

FIG. 4 illustrates Anonymous Certificate distribution with a Proxy CA;

FIG. 5 illustrates vehicle Anonymous Certificate management with a Proxy CA;

FIG. 6 illustrates a Proxy CA and Vehicle Certificate manager communications; and

FIG. 7 illustrates interaction between a neighborhood CA and vehicles.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

### Overview of Proxy Certificate Authority (CA)

A Proxy CA may be viewed as application software that runs on wireless mobile devices and enables the update of vehicle certificates and CRLs. It communicates with certificate authorities and servers using Internet Protocol (IP) communications services provided over the wireless communications mechanism native to the mobile device and maintains a local store of certificate updates and the latest CRLs. It also communicates with the vehicle's on-board computer unit (OBU) to download the latest CRLs to the vehicle and updates its certificates.

Preferably, a Proxy CA communicates with a Vehicle Certificate Manager, which is application software that runs on the vehicle OBU. Their communications may take place over Bluetooth, serial port, or other means of bi-directional communications capabilities available on the vehicle OBU.

The word, “proxy,” is used to indicate that the Proxy CA proxies the CAs to the vehicle OBU. In general, the main functions of the Proxy CA are to:

Securely acquire and maintain local copies of the identifying and anonymous certificates for a set of associated vehicles. The association is established at the time of vehicle purchase as described below.

Download, cache, and transfer Certificate Revocation Lists (CRLs), not only to its associated vehicles but to other vehicles.

Download, cache, and transfer shared anonymous certificates to be rekeyed (also termed updated) to other vehicles.

Note that the Proxy CA is associated with one or more vehicles for which it enables the update of their identifying and anonymous certificates. The association allows the Proxy CA to make requests and receive replacement identifying certificates on behalf of the vehicles; however, the Proxy CA does not learn any identifying information about the vehicle itself. It also works as a proactive (or push) mechanism to distribute CRLs and shared anonymous certificates to other vehicles as long as it can establish a communication channel with their Vehicle Certificate Managers.

By working as a mobile cache of the latest CRLs and anonymous certificates to be rekeyed, it can distribute the CRLs and update certificates to as many vehicles as possible and as quickly as possible. In turn, the vehicles themselves can distribute CRLs and shared anonymous certificates to a wider population via native V2V broadcast mechanisms. In short, the Proxy CA is a flexible, inexpensive, and widely deployable mechanism for distributing CRLs and updating shared anonymous certificates using network connectivity that drivers are likely to bring into the vehicle and thereby overcome the constraints of no (or limited) deployment of dedicated roadside infrastructure in the vehicle network environment.

### Architectural Components

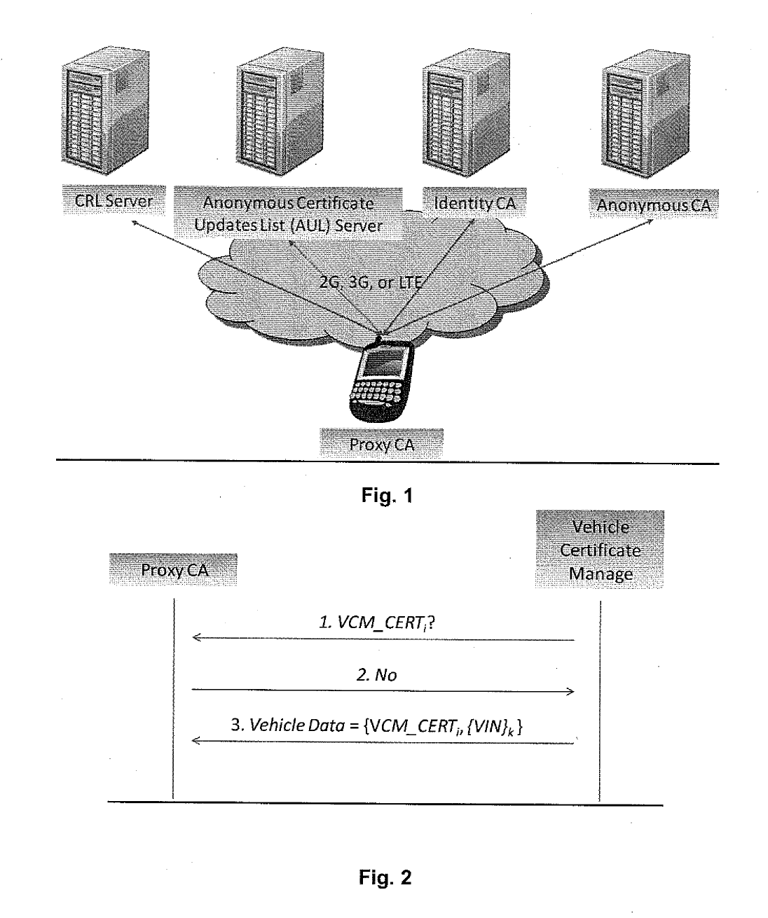

FIG. 1 graphically shows the architectural components needed to manage vehicle certificates by means of the Proxy CA. The key components are:

Vehicle Identity Certificate Authority (CA)—manages vehicle identifying certificates

Anonymous CA—manages vehicle anonymous certificates

Anonymous Certificate Updates List Server (AUL Server)—distributes vehicle anonymous certificates

CRL Server—distributes Certificate Revocation Lists

Proxy CA—application software that runs on a mobile wireless device, such as PDAs and smart phones, and acquires and maintains local storage of certificate updates and the latest CRLs by communicating with the Identity CA, Anonymous CA, AUL Server and CRL Server through its native network connectivity, such as commercial wireless service, and makes them available to one or more vehicles.

Vehicle Certificate Manager (not shown in FIG. 1)—application software that runs on the vehicle OBU and manages vehicle identifying and anonymous certificates by communicating with the Proxy CA when a dedicated roadside infrastructure is not available.

The functional roles of these components are described and discussed in detail below. CAs, CRL, and AUL servers are functional components. The exact architectural arrangement of a given component depends on specific implementation and deployment requirements, which are known to those skilled in the art and are not dealt with herein.

### Assumptions

Preferably, all the CAs and Vehicle Certificate Manager are provisioned with digital certificates that allow mutual authentication of each other. The digital certificate of the Vehicle Certificate Manager uniquely identifies the Vehicle Certificate Manager and does not contain any information about the vehicle or OBU on which it runs. The Vehicle Certificate Manager can access and use the private and public keys of the vehicle's certificates.

### Initial Provisioning

In this section, we describe the initial provisioning tasks that are performed to allow the Proxy CA to interact a vehicle to update its identifying and anonymous certificates of a given vehicle. When the vehicle is manufactured, the vehicle OEM installs on the vehicle OBU:

Vehicle Certificate Manager software

Trusted root certificate to validate the certificates of Identity CA and Anonymous CA

Identifying and anonymous private, public key pairs for the Vehicle Certificate Manager

VCM_CERTᵢ, the Vehicle Certificate Manager's digital certificate trusted by the Identity CA

{VIN}ₖ, a ciphertext produced by computing a digital signature of the vehicle's identification number (VIN) with VCM_CERTᵢ and then encrypting the VIN and the digital signature with the public key of the Identity CA

At the time of vehicle sale, the dealership or vehicle owner preferably performs the following tasks (assuming the vehicle OBE is Bluetooth-capable):

Install the Proxy CA software on the customer's mobile device

Check the pre-configured address information of the CAs, CRL, and AUL servers in the Proxy CA software

Establish the vehicle OBU and customer's mobile device as Bluetooth peers

Activate the Proxy CA and Vehicle Certificate Manager on the customer's mobile device and vehicle OBU respectively

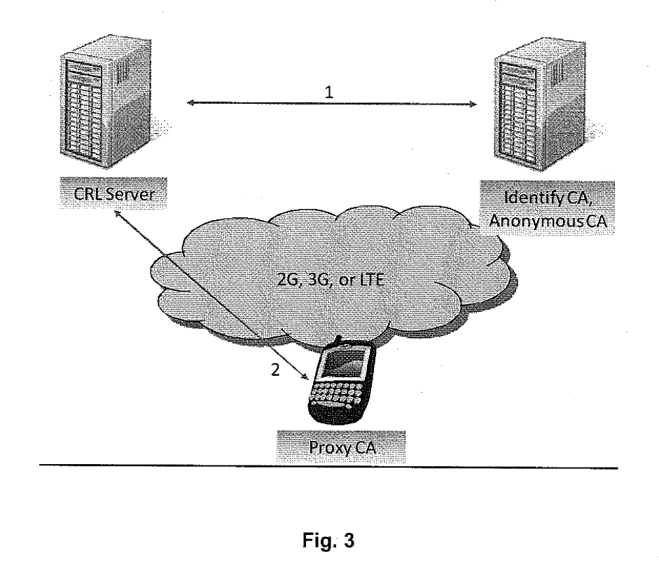

Subsequently, the customer's mobile device and vehicle OBU establish a Bluetooth connection, and the Proxy CA and Vehicle Certificate Manager discover each other. At this point, the Proxy CA and Vehicle Certificate Manager proceed to run a vehicle data transfer protocol shown in FIG. 2.

The possession of valid vehicle data allows the Proxy CA to receive the vehicle's identifying and anonymous certificates from the CAs. In Step 1 of FIG. 2, the Vehicle Certificate Manager sends the serial number of its VCM_CERTᵢ as a way of asking if the Proxy CA has its vehicle data. If the Proxy CA answers no (as shown in Step 2 of FIG. 2), the Vehicle Certificate Manager sends {VCM_CERTᵢ, {VIN}ₖ}, called Vehicle Data, to the Proxy CA, which stores it. If the Proxy CA answers yes, the Vehicle Certificate Manager understands that the Proxy CA already has its Vehicle Data. The Vehicle Certificate Manager may seek the customer's approval before sending the Vehicle Data in Step 3 of FIG. 2 by alerting the customer with a pop-up dialog box on the dashboard display of the vehicle or other user interface (UI) mechanisms and waiting for his or her response. Alternatively, the customer may have pre-configured the Vehicle Certificate Manager to acquire updates when available.

Note that multiple instances of the Vehicle Data from different vehicles can be stored on the same mobile device. This enables the Proxy CA to interact and support multiple vehicles. Also note that only the Identity CA can decrypt {VIN}ₖ with its own private key and verify the digital signature and integrity of the VIN data with the public key of the Vehicle Certificate Manager. Therefore, the Proxy CA, or an attacker of the mobile device, cannot learn any information about the vehicle because the information is encrypted.

Subsequent to the transfer of the Vehicle Data, the Proxy CA and Vehicle Certificate Manager proceed to download and install the identifying and anonymous certificates in the vehicle. In addition, the Proxy CA also downloads the CRLs of identifying and anonymous certificates and transfers them to the Vehicle Certificate Manager. The processes for these tasks are preferably the same as the ones used during normal operation.

### CRL Management and Distribution

Certificate Revocation Lists (CRLs) are public data meant to be openly distributed to any entity or application that needs them. For integrity protection and authentication, a CRL is typically accompanied by a digital signature of the CA that has issued it.

Three methods may be used to distribute CRLs to vehicles. These are:

CRL Downloads to Proxy CA

CRL Seeding with V2V Distribution

CRL Broadcast via Satellite

One or all methods can be used in combination with one another to improve the timeliness of CRL distribution and coverage in the population of vehicles.

### CRL Downloads to Proxy CA

To facilitate CRL distribution, we introduce the concept of a CRL Server, which downloads CRLs to the Proxy CA on a request-response basis. FIG. 3 graphically illustrates the process of CRL distribution to the Proxy CA. First, the Identity CA and Anonymous CA periodically publish the latest CRLs of identifying certificates and anonymous certificates, respectively, to the CRL Server. The CRL publication includes timestamp or version information.

Meanwhile, the Proxy CA periodically contacts the CRL server to determine if new CRLs have been published. It retrieves the timestamp or version information of the latest CRLs and compares them with those of the CRLs it has previously downloaded. Finally, the Proxy CA downloads the latest CRLs from the CRL Server on an as-needed basis.

The CRL Server may be implemented as a Web server, and the Proxy CA as a Web client, and the HTTP protocol over TCP/IP may be used to realize the described request-response communications and transfer of CRLs. The Proxy CA stores the received CRLs on the mobile device and transfers them to the Vehicle Certificate Manager of any vehicle with which it can establish a Bluetooth connection.

CRL Seeding with V2V Distribution

A second means to distribute CRLs that can coexist with Proxy CA distribution is to seed some vehicles with the latest CRL and enable them to propagate it to the vehicle network using V2V communications. A convenient seeding mechanism is to install the latest CRL in new vehicles during production. Each year approximately 10 to 15 million new vehicles are introduced into the vehicle population in the US, which is fairly stable from year to year at about 200 million vehicles, with a slight growth likely following the population growth.

New vehicles can be equipped with the current CRL to provide a 5 to 7.5% seeding of the vehicle population on yearly basis. A major benefit of this method is that it takes advantage of an existing process and introduces no infrastructure connectivity requirements in the vehicle network.

Another method of seeding is to deploy the latest CRL on government vehicles, such as police cars and emergency vehicles, which already have infrastructure connectivity independent of vehicle networks. The CRL can propagate as these vehicles interact with the vehicle population in the normal course of their activity.

The propagation of CRLs from vehicle-to-vehicle can occur using a simple V2V protocol. When vehicles communicate with one another, they each can broadcast their CRL version as part of their normal safety messaging. The vehicle with the most current CRL then broadcasts it to the group. Vehicles with older CRLs acquire the more recent CRL and begin to use and propagate it to other vehicles. Given that the CRL is signed by an entity trusted by all vehicles, the origin and integrity of the CRL can be determine by each vehicle to attest to its legitimacy.

### CRL Broadcast via Satellite

Another means to distribute CRLs is to piggyback on existing one-way broadcast services for consumer entertainment. Specifically, many vehicles, particularly new vehicles, come equipped with satellite radio receivers to decode digital radio broadcasts. CRLs can be periodically broadcast to all vehicles within the coverage area of the satellite. With the current satellite fleet used by the provider Sirius, at least one of its three satellites broadcast directly over the US at times, enabling CRLs to be broadcast to the entire vehicle population in a single instance. Due to signal blockage caused by large buildings, natural structures and other facilities, such as indoor and underground parking lots, CRLs would be periodically broadcast to provide multiple opportunities for CRL acquisition. A major benefit of this approach is that it leverages the satellite receiver already built into most new vehicles and does not require any additional dedicated vehicle hardware. However, it does require bandwidth on satellite transmissions, which is generally an expensive mode of communication.

A benefit of V2V propagation with satellite broadcast is that it may not require satellite receivers to be a critical part of the safety system for each vehicle.

Anonymous Certificate Distribution with Proxy CA

In conventional certificate management, the owner of a given certificate initiates the process of updating the certificate when it expires (or is about to expire) or if its certificate is found on a CRL. In other words, it is the responsibility of the certificate holder to take proactive actions in the overall certificate management scheme. Anonymous certificates may be managed in a combinatorial certificate management scheme where each vehicle acquires a small number of certificates from a certificate pool that is shared by multiple vehicles. However, having individual vehicles update a shared anonymous certificate in separate, independent transactions is inefficient. Furthermore, having each vehicle update anonymous certificates on its own in an intermittent network environment may introduce too much delay and increase security risks.

Instead, a proactive approach to anonymous certificate management is presented, in which the Anonymous CA periodically publishes a list of Anonymous Certificates to be replaced. It can do so because it knows the expiration dates of anonymous certificates and whether a certificate has been placed on the CRL. When the Vehicle Certificate Manager receives an Anonymous Certificate List (AUL) (from the Proxy CA), it processes the list to determine if the vehicle has the anonymous certificates being replaced and installs new certificates and key pairs on an as-needed basis.

An AUL has more security requirements than a CRL. Specifically, all the entries in a CRL are meant to be received and processed by the entire vehicle population, while each entry in an AUL is meant to be received and installed on a small subset of the vehicle population. Therefore, not only does the entire content of an AUL need to be integrity-protected (like a CRL), but also each entry in the AUL should be cryptographically secured so that only the authorized vehicles can have new certificates.

Therefore, an entry in an AUL consists of the following elements:

SERIAL_NO, the serial number (or its hash) of old anonymous certificate being replaced

{NEW_CERT}_{old}_{_{—}}ₖ, a new anonymous private/public key pair, the corresponding anonymous certificate, and

the Anonymous CA's digital signature on the key pair and certificate, all of which are encrypted with the public key, old_k, of the old anonymous certificate

As is the case with a CRL, the Anonymous CA's digital signature secures the integrity of the entire content of a given AUL.

Preferably, only the current holder of a to-be-replaced anonymous certificate can decrypt {NEW_CERT}_{old}_{_{—}}ₖ and gain access to the replacement certificate and the corresponding key materials. The serial number of an old anonymous certificate is included to allow the Vehicle Certificate Manager on the vehicle OBU to quickly determine if the vehicle has the old anonymous certificate. The replacement certificate has its own, unique serial number.

Anonymous certificates in a shared certificate management scheme provide privacy by virtue of each individual certificate is held by multiple certificates. The Anonymous CA issues a given anonymous certificate to a given vehicle in a way that maximizes the certificate's likelihood of being co-owned by neighboring vehicles. The described anonymous certificate management approach ensures that the new anonymous certificate has the same likelihood of co-ownership as the one that it replaces without the Anonymous CA performing additional computations.

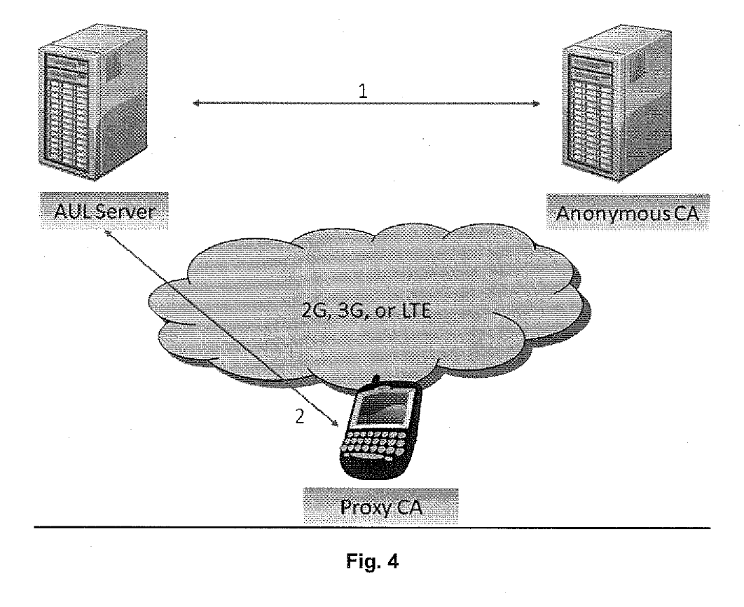

To realize the described anonymous certificate management scheme, we introduce a new system component, called the Anonymous Certificate List Server (AUL Server), as shown in FIG. 4. From a functional, and architectural point of view, the AUL Server plays a similar role to that of the CRL Server in that it stores anonymous certificate lists (AULs) published by the Anonymous CA and distributes AULs to the Proxy CA on a request-response basis.

Similarly, the Proxy CA periodically communicates with the AUL server to determine if new AULs have been published. It retrieves the timestamp or version information of the latest AULs and compares them with those of the AULs it has previously downloaded.

Finally, the Proxy CA downloads the latest AULs from the AUL Server on an as-needed basis. The AUL Server may be implemented as a Web server, and the Proxy CA as a Web client, and the HTTP protocol over TCP/IP may be used to realize the described request-response communications and transfer of AULs. The Proxy CA stores the received AULs on the mobile device and transfers them to the Vehicle Certificate Manager of any vehicle with which it can establish a Bluetooth connection. Furthermore, AULs can be distributed among vehicle by V2V communication.

While AULs distributed by proxy CAs and V2V communication provide a convenient means to replace anonymous certificates in a fashion that maintains the distribution properties of the shared certificate pool, a mechanism is also needed to enable the Anonymous CA to deny certificate replacement to vehicles that are misbehaving. Gratuitous AUL distribution allows any vehicle with one or more certificates on the list to install a replacement, but it does not provide the means to deny certificate replacements to specific vehicles.

To address the need for the removal of misbehaving vehicles, additional criteria for creating AULs is imposed, and the two-way communications capability of the proxy CA is invoked. Specifically, AULs are managed by the Anonymous CA such that an anonymous certificate is not replaced by means of AUL publication more than a maximum number of times, MAX_REKEY.

in addition, the Anonymous CA does not include in the AUL an anonymous certificate that an intrusion detection system (IDS) has identified as having been misused. The consequence of these two management rules is that all vehicles will eventually deplete their store of valid anonymous certificates and need to make an explicit request to its associated Proxy CA to pull replacement anonymous certificates directly from the Anonymous CA, a process which is similar to the one for initially provisioning anonymous certificates in vehicles. During this process, the Identity or Anonymous CA can interact with its respective intrusion detection system and determine whether or not to rekey the vehicle.

There may be a case in which a group of vehicles may have the same set of anonymous certificates. In such an unlikely scenario, or when anonymous certificates should individually be replaced one at a time, the vehicles may request for replacement anonymous certificates at the same time, which can increase the processing load on the Anonymous CA. To this end, each Vehicle Certificate Manager can wait for a random period of time subsequent to determining the need for replacement certificates.

The concept of placing a maximum on certificate publication is consistent with imposing a rekeying threshold on all vehicles for the combinatorial certificate management scheme in that each vehicle will be able to rekey a certain number of times before additional scrutiny. AUL distribution via the Proxy CA or V2V communication helps makes this process more efficient.

Comparison to Anonymous Certificate Distribution by Satellite Broadcast

Replacements for anonymous certificates can be also distributed via satellite broadcast using the same AUL concept. Instead of the AUL server downloading the AUL to a Proxy CA, it would interconnect with a satellite broadcast system that would periodically transmit the AUL directly to vehicles in the satellite's coverage area. Upon acquiring the AUL through their satellite receivers, the Vehicle Certificate Manager would perform the certificate replacement process as previously described.

While providing efficient distribution of certificate replacements, the satellite broadcast of AULs does not provide the means for the CA to deny certificate replacement to vehicles that have been identified as misbehaving. Since satellite broadcasts are one-way and do not provide the means for vehicles to contact the Anonymous CA for certificate replacement, the application of the AUL management rules used in the case of the Proxy CA result in a permanent depletion of certificates. The Proxy CA approach with its two-way communication provides a more advantageous solution that supports the removal of misbehaving vehicles.

Vehicle Identifying Certificate Management with Proxy CA

To update the identifying certificates of its associated vehicle, the Proxy CA periodically, or on request by the Vehicle Certificate Manager on the vehicle OBU, communicates with the Identity CA. First, the Proxy CA sends the Vehicle Data of its associated vehicle to the Identity CA. The Vehicle Data is cryptographically secured so that only the Identity CA can decrypt {VIN}ₖ in the Vehicle Data and check the integrity of the decrypted VIN by verifying the accompanying digital signature with the Vehicle Certificate Manager's digital certificate.

Upon receiving the request from the Proxy CA, the Identity CA retrieves the VIN from the received Vehicle Data and determines if any identifying certificates have been issued for the corresponding vehicle and checks the status of each issued certificate. It also records {VIN, VCM_CERTᵢ} for later use (for example, when authorizing the Anonymous CA to issue anonymous).

Subsequently, the Identity CA sends the following data to the Proxy CA in its response to the received request:

{ID_CERTS}ₖ, new or replacement vehicle identifying certificates, if any, signed by the Identity CA and encrypted with symmetric keys generated by the Identity CA

{ID_KEYS}ₖ, the above symmetric keys signed by the Identity CA and encrypted with the Vehicle Certificate Manager's public key

The Identity Server may be implemented as a Web server, and the Proxy CA as a Web client, and the HTTP protocol over TCP/IP may be used to realize the described request-response communications. The Proxy CA stores the {ID_CERTS}ₖ and {ID_KEYS}ₖ on the mobile devices until it sends them to the Vehicle Certificate Manager of the associated vehicle.

The Proxy CA, or the attacker of the mobile device, preferably cannot retrieve the plain text of identifying certificates from {ID_CERTS}ₖ without having first compromised the vehicle OBU and obtained the private key of the Vehicle Certificate Manager. As such, storing {ID_CERTS}ₖ and {ID_KEYS}ₖ on the mobile device does not incur new security risks.

Initial Provisioning of Vehicle Anonymous Certificates Management Through Proxy CA

As noted above, the Anonymous CA manages anonymous certificates by way of publishing anonymous certificate lists (AULs) via the AUL Server. However, it still needs to issue anonymous certificates to individual vehicles when the vehicle is put into service for the first time. The provisioning of the initial set of anonymous certificates may occur during OBE assembly, vehicle manufacture, or vehicle sale. To this end, the Proxy CA is used to provision the initial set of certificates by “pulling” anonymous certificates from the Anonymous CA when it first receives the Vehicle Data from the Vehicle Certificate Manager. A critical goal of this transaction is to provide the same level of security as when issuing vehicle identifying certificates while preserving the identity of the vehicle hidden from the Anonymous CA.

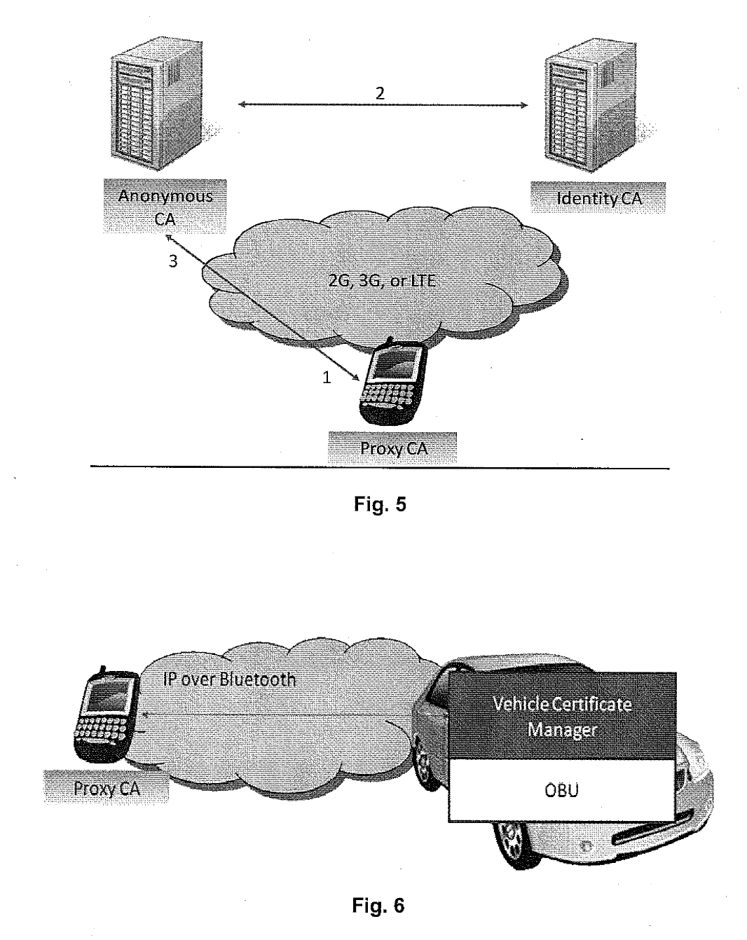

Another goal is to allow the Anonymous CA to keep track of how often the vehicle has asked for replacement anonymous certificates. If the frequency is too high, the vehicle may be a “bad actor,” and an appropriate action should be taken. To remove “bad actors” from the system, the Anonymous CA collaborates with the Identity CA as graphically illustrated in FIG. 5.

To pull the anonymous certificates, the Proxy CA first sends the {VIN}ₖ in the Vehicle Data to the Anonymous CA, which forwards it to the Identity CA. As when issuing identifying certificates, the Identity CA determines the authenticity of the received {VIN}ₖ by decrypting and checking the data integrity of the VIN. For the latter, the Identity CA first looks up the certificate, VCM_CERTᵢ, of the Vehicle Certificate Manager associated with the VIN. If successful, the Identity CA sends the Anonymous CA a permission to issue anonymous certificates. If unsuccessful, the Identity CA instructs the Anonymous CA to deny the request from the Proxy CA.

When authorizing the Anonymous CA to issue anonymous certificates, the Identity CA sends the following data to the Anonymous CA:

Symmetric keys to encrypt the anonymous certificates

{ANONY_KEYS}ₖ, the above keys signed by the Identity CA and encrypted with the public key of the Vehicle Certificate Manager

Upon receiving the authorization from the Identity CA, the Anonymous CA generates the replacement anonymous certificates, digitally signs them with its own certificate, and encrypts them with the symmetric keys received from the Identity CA. Subsequently, the Anonymous CA sends the following data to the Proxy CA:

{ANONY_CERTS}ₖ, replacement anonymous certificates signed by the Anonymous CA and encrypted and integrity-protected with the symmetric keys generated by the Identity CA

{ANONY_KEYS}ₖ, the above keys signed by the Identity CA and encrypted with the public key of the Vehicle Certificate Manager

Subsequently, the Anonymous CA notifies the Identity CA of the number of replacement anonymous certificates issued to the vehicle with {V/N}ₖ and time of issuance. This information allows the Identity CA to keep track of the history of anonymous certificate issuance, which, in turn, can be used for detection of compromised vehicles and/or bad actors. Note that the identity CA does not know what anonymous certificates have been issued to the vehicle, while the Anonymous CA does not know the identity of the vehicle.

Proxy CA stores {ANONY_CERTS}ₖ and {ANONY_KEYS}ₖ on the mobile devices until it can send them to the Vehicle Certificate Manager of the associated vehicle. Note that the Proxy CA, or the attacker of the mobile device, cannot retrieve the plaintext of anonymous certificates without having first compromised the vehicle OBU and obtained the private key of the Vehicle Certificate Manager. As such, storing {ANONY_CERTS}ₖ and {ANONY_KEYS}ₖ on the mobile device does not incur new security risks.

Proxy CA and Vehicle Certificate Manager Communications

In this section, we give an overview of Bluetooth-based communications between the Proxy CA and the Vehicle Certificate Manager of the associated vehicle as shown in FIG. 6. Proxy CA provides a Bluetooth service, in which it functions as the server while the Vehicle Certificate Manager as the client. Bluetooth Device and Service Discovery mechanisms are used for the Vehicle Certificate Manager client to detect the presence of the Proxy CA server. The service uses the Bluetooth Object Push Profile (or File Transfer Profile) to transfer from the Proxy CA's mobile device to the Vehicle Certificate Manager's OBU the following:

{ID_CERTS}ₖ

{ID_KEYS}ₖ

{ANONY_CERTS}ₖ

{ANONY_KEYS}ₖ

AULs

CRLs

Because {ID_CERTS}ₖ, {ID_KEYS}ₖ, {ANONY_CERTS}ₖ, and {ANONY_KEYS}ₖ are only for the vehicle associated with a given Proxy CA, a secure Bluetooth connection may be used, while the transfer of AULs and CRLs can take place over open Bluetooth connections. Note that all the data elements are cryptographically secured with digital certificates of the Identity and Anonymous CAs and Vehicle Certificate Managers. Therefore, the attacker cannot acquire plain certificate data unless he or she has already compromised one or more of these systems. Therefore, the transfer of these data elements over Bluetooth does not presently add new security risks to certificate data.

The described data transfer service can be augmented with a discovery mechanism or protocol that allows the Vehicle Certificate Manager to determine if it needs to transfer the AULs and CRLs from the Proxy CA's mobile device in the first place. For example, the service's Bluetooth URL can contain timestamp parameters that indicate the time and date of the Proxy CA's previous CRL and AUL downloads. Such information can be used by the Vehicle Certificate Manager to determine if it should connect to the service in the first place.

Discussion

The Proxy CA provides a vehicle certificate management method that requires no dedicated roadside network infrastructure. It should be noted that the function of updating certificates for individual vehicles is cleanly separated from that of updating CRLs and AULs on a vehicle population. This increases the flexibility in how the Proxy CA-based system can be deployed. For example, the function of distributing CRLs and AULs can be implemented on “public” radio devices, such as those issued for police work, while consumer mobile devices are used to update certificates on associated vehicles only. In this arrangement, consumer mobile devices can be freed from downloading and distributing data meant for public consumption.

Furthermore, end users can completely rely on “public” means for total certificate management on an opt-in basis as follows. The Vehicle Certificate Manager of an opted-in vehicle sends the Vehicle Data to the Vehicle Certificate Manager on, for example, a neighborhood patrol car via a (DSRC) V2V broadcast mechanism. This establishes an association between the vehicle and the neighborhood patrol car. The Proxy CA on the patrol car then sends the Vehicle Data to the Proxy CA on a networked wireless device or computer, which acquires identifying and anonymous certificates from the CAs and transfers them back to the Vehicle Certificate Manager of the patrol vehicle OBU, which, in turn, transfers them to the associated vehicle via the same V2V broadcast mechanism. In this function, the Vehicle Certificate Manager on the patrol vehicle is called the Neighborhood Proxy CA, which completely frees opted-in end users from having to use their mobile devices to manage certificates, Note that the request-response transaction between the Neighborhood Proxy CA and vehicles may be asynchronous. The Neighborhood Proxy CA can indicate its presence to nearby vehicles by broadcasting a message with a unique ID signed with a digital certificate issued by the Identity CA. This way, a vehicle can recognize a Neighborhood CA to which it has sent a certificate update request (by sending its Vehicle Data) and retrieve update certificates by broadcasting its presence.

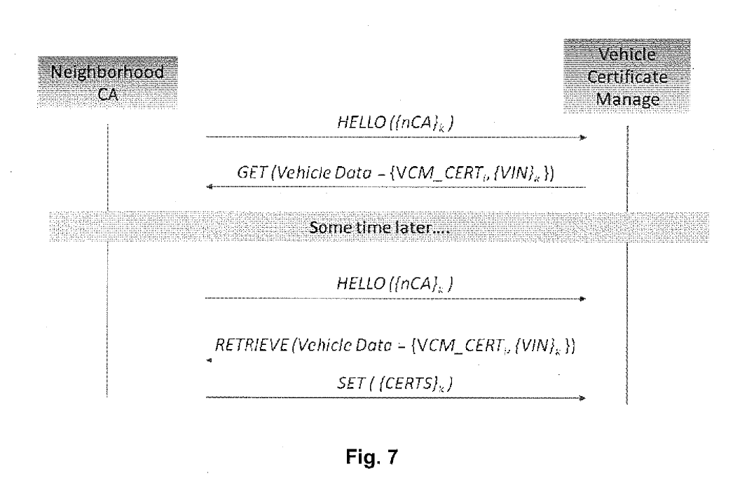

FIG. 7 graphically illustrates the interaction between the Neighborhood Proxy CA and vehicles. In FIG. 7, {nCA}ₖ is the unique ID of the Neighborhood Proxy CA signed with a certificate issued by the Identity CA. All the messages, HELLO, GET, RETRIEVE, and SET, are broadcast messages. HELLO announces the presence of the Neighborhood Proxy CA, GET is the vehicle's request to the Neighborhood Proxy CA to acquire update certificates, RETRIEVE announces the vehicle's presence to the Neighborhood Proxy CA, and SET sends the update certificates to the vehicle. The {CERTS}ₖ parameter in the SET message indicates the identifying and anonymous update certificates for the vehicle cryptographically.

The described concept of the Neighborhood proxy CA takes advantage of the fact that the residents in a given community tend to have repeating travel patterns and that the number of vehicles in a given community is much smaller than that on major highways or roadways. The former increases the likelihood that neighborhood patrol vehicles and resident vehicles will encounter each other frequently. The latter reduces the inefficiency in network bandwidth usage in broadcasting identifying certificates by increasing the likelihood that a given broadcast message will contain identifying certificates relevant to vehicles in the same radio coverage area.

Note that the OBU on the Neighborhood Proxy CA vehicle does not function as a roadside network infrastructure unit. Rather, it functions as a special OBU capable of receiving the Vehicle Data of and transmitting updated certificates to associated vehicles over the broadcast medium.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. An apparatus for use in a system for managing digital certificates, said system including a certificate authority and a vehicle-bound digital certificate manager, said apparatus comprising:
a mobile client having a wireless transceiver with internet protocol capabilities and a vehicle communication device;
said client further including at least one processor and at least one non-transitory computer readable medium encoded with instructions, which when loaded on said at least one computer, establish processes for information handling, comprising:
establishing secure communications with a certificate authority to receive at least one of a Vehicle Identification Digital Certificate (“VIDC”), an Anonymous Vehicle digital Certificate (“AVDC”), and a Certificate Revocation List (“CRL”);
storage management of at least one of said VIDC, AVDCs, and CRLs; and
forwarding of at least one of said VIDC, AVDCs, and CRLs received from said certificate authority to said digital certificate manager using said vehicle communication device.

2. An apparatus for use in a system for managing digital certificates, said system including a mobile client having a wireless transceiver with internet protocol capabilities said apparatus comprising:
a vehicle on-board computer unit, including a vehicle communication device and a vehicle-to-vehicle wireless communication device;
said vehicle on-board computer unit further including at least one processor and at least one non-transitory computer readable medium encoded with instructions, which when loaded on said at least one computer, establish processes for information handling, comprising:
establishing secure communications with said mobile client via said vehicle communication device and receiving of at least one of a Vehicle Identification Digital Certificate (“VIDC”), an Anonymous Vehicle digital Certificate (“AVDC”), and a Certificate Revocation Lists (“CRLs”);
storage management of at least one of said VIDC, AVDCs, and CRLs received from said mobile client; and
forwarding of at least one of said AVDCs and CRLs received from said mobile client to another vehicle using said vehicle-to-vehicle wireless communication device.

3. The apparatus of claim 1 further including:
said vehicle on-board computer unit including a vehicle communication device and a vehicle-to-vehicle wireless communication device;
said vehicle on-board computer unit further including at least one processor and at least one non-transitory computer readable medium encoded with instructions, which when loaded on said at least one computer, establish processes for information handling, comprising:
establishing secure communications with said mobile client via said vehicle communication device and receiving of at least one of a Vehicle Identification Digital Certificate (“VIDC”), an Anonymous Vehicle digital Certificate (“AVDC”), and a Certificate Revocation Lists (“CRLs”);
storage management of at least one of said VIDC, AVDCs, and CRLs received from said mobile client; and
forwarding of at least one of said AVDCs and CRLs received from said mobile client to another vehicle using said vehicle communication device.

4. A method for managing digital certificates in a system including a certificate authority and a vehicle-bound digital certificate manager, said method comprising:
receiving on a wireless client from said certificate authority at least one of a Vehicle Identification Digital Certificate (“VIDC”), one or more Anonymous Vehicle Digital Certificates (“AVDCs”), and one or more Certificate Revocation Lists (“CRLs”);
storing at least one of said VIDC, AVDCs, and CRLs; and
forwarding of at least one of said VIDC, AVDCs, and CRLs from said wireless client to said vehicle-bound digital certificate manager using a vehicle communication device.

5. The method of claim 4 further comprising:
forwarding of at least one of said AVDCs and CRLs received from said mobile client to another vehicle using a vehicle-to-vehicle wireless communication device.

6. The apparatus of claim 1 wherein said vehicle communication device comprises one of a Bluetooth, WiFi, or wireless serial port two-way communication device.

7. The apparatus of claim 2 wherein said vehicle communication device comprises one of a Bluetooth, WiFi, or wireless serial port two-way communication device.

8. The apparatus of claim 3 wherein said vehicle communication device comprises one of a Bluetooth, WiFi, or wireless serial port two-way communication device.

9. The method of claim 4 wherein said vehicle communication device comprises one of a Bluetooth, WiFi, or wireless serial port two-way communication device.

10. The apparatus of claim 1 wherein said mobile client comprises at least one of a cellular phone, PDA, or smart phone.

11. The apparatus of claim 2 wherein said mobile client comprises at least one of a cellular phone, PDA, or smart phone.

12. The apparatus of claim 3 wherein said mobile client comprises at least one of a cellular phone, PDA, or smart phone.

13. The method of claim 4 wherein said wireless client comprises at least one of a cellular phone, PDA, or smart phone.

14. The method of claim 5 wherein said wireless client comprises at least one of a cellular phone, PDA, or smart phone.

15. The method of claim 4 further including receiving periodically published a list of ADVCs to be replaced.

16. The method of claim 15 wherein at least one entry of said list of ADVCs to be replaced includes:
a serial number or a hash of the serial number of old anonymous certificate being replaced {NEW_CERT}_{old}_{_{—}}ₖ,
a new anonymous private/public key pair, the corresponding anonymous certificate, and
the Anonymous CA's digital signature of the key pair and certificate, all of which are encrypted with the public key, old_k, of the old anonymous certificate.

17. The method of claim 4 wherein said wireless client sends the VIN of vehicle for which said method is being applied to a certificate authority.

18. The apparatus of claim 1 wherein said wireless client includes storage management for:
replacement anonymous certificates, {ANONY_CERTS}ₖ, signed by an Anonymous Certificate Authority and encrypted and integrity-protected with symmetric keys generated by an Identity Certificate Authority; and
{ANONY_KEYS}ₖ, the above keys signed by the Identity CA and encrypted with the public key of said vehicle-bound digital certificate manager

19. The method of claim 5 including storing in said wireless client:
replacement anonymous certificates, {ANONY_CERTS}ₖ, signed by an Anonymous Certificate Authority and encrypted and integrity-protected with symmetric keys generated by an Identity Certificate Authority; and
{ANONY_KEYS}ₖ, the above keys signed by the Identity CA and encrypted with the public key of vehicle-bound digital certificate manager.
